(19) United States
(12) Patent Application Publication
(10) Pub. No.: US 2006/0155759 A1
(43) Pub. Date: Jul. 13, 2006

(54) Scalable cache layer for accessing blog content

(75) Inventors: Vijay S. Ramachandran, Bangalore (IN); Yathin S. Kirshnappa, Bangalore (IN); Hitesh S. Shah, Mumbai (IN)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/027,818

(22) Filed: Dec. 29, 2004

(51) Int. Cl. G06F 17/00

(52) U.S. Cl. 707/103 X

(57) ABSTRACT

Methods, devices, and systems are directed towards a caching layer for managing access to blog content. The invention includes a caching layer that communicates with a web server and a database server. The caching layer includes a plurality of slots arranged to hold information. The web server is directed to the caching layer for information. If the information is not in the caching layer, the caching layer accesses it from the database. When information from the database is accessed, it is transferred into a slot in the caching layer. An index associated with each slot is usable to further improve access to cached information. When a slot is unavailable, the slot may be automatically emptied. The emptied slot may then be available to receive additional information. The slot may be emptied when without querying when the information was placed in the caching layer or when the information was last accessed.

### FIELD OF THE INVENTION

The invention is directed to accessing information, and in particular, but not exclusively, to employing a scalable caching layer having at least one slot for use in accessing blog content.

### BACKGROUND OF THE INVENTION

The amount of stored and generally accessible information has grown at an astounding rate, particularly with the advent and subsequent popularity of the Internet. Much of the information is maintained on databases. Databases can be used to store information such as, for example, webpages, messages on message boards, and compilations of documents or images. When the information is needed, the database is queried and the information found and displayed. As the amount of information in the database grows, the time to search for information on the database increases.

As one example of a relatively new database application, weblogs or, more commonly, blogs, have become an increasingly popular forum for communication and discussion. Blogs are typically a publicly accessible personal journal written by an individual who is often referred to as a “blogger”. Blogs can be updated daily or more or less frequently and on a more or less regular basis. The entries to the blog are generally displayed in reverse chronological order so that the latest information is at the top of the page. Each blog entry also typically includes a date stamp. The content of blogs varies widely with some blogs dedicated to particular subjects or to particular interests of the blogger and other blogs sharing the random thoughts and activities of their creators.

In addition to the journal, blogs often allow readers to post messages related to the blog entry. This allows discussion and exchange between and among the blogger and his readers. Service providers can create an environment in which bloggers can set up and operate their individual blogs. A database supporting one or more blogs can become very large, particularly if the blog(s) are active with journal articles and messages from readers.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 schematically illustrates an example of an operating environment, according to the invention;

FIG. 2 schematically illustrates an example of a server, according to the invention;

FIG. 3 schematically illustrates, in more detail, one embodiment of a portion of the operating environment of FIG. 1;

FIG. 4 schematically illustrates one embodiment of a caching layer, according to the invention;

FIG. 5 is a flow chart illustrating one embodiment of a method for accessing information, according to the invention;

FIG. 6 is a flow chart illustrating one embodiment of a method for using a caching layer to store information, according to the invention; and

FIG. 7 is a flow chart illustrating another embodiment of a method for using a caching layer to store information, according to the invention.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure may be thorough and complete, and may fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed to using a scalable caching layer for accessing information. The scalable caching layer may be employed to improve access to, for example, blog content. The caching layer may reside within one or more cache servers that communicate with one or more web servers and one or more database servers. The database servers include a database of information. When a user requests database information from a web server, the web server can look to the caching layer first, to determine if the information is there to provide to the user. If the information is not in the caching layer, then a database server is queried for the information.

The caching layer includes a plurality of slots, where each slot may hold a number of items of information. When information from the database is accessed, it is transferred into a slot in the caching layer. Thus, the caching layer includes a collection of the most recently accessed information from the database. This is the most likely source of information for future requests for database information and can facilitate the accessing of database information, because the entire database need not be searched if the information is in the caching layer. In one embodiment, the information within the slots may then be located employing an index. In another embodiment, a plurality of indices is used, where each index in the plurality is associated with accessing information within a different slot in the plurality of slots. Usage of the plurality of indices is intended to improve finding information within the slots over other traditional approaches.

When a slot in the caching layer is determined to be unavailable for storing additional information, for example, because it is determined to be full, the slot may be automatically emptied. The emptied slot may be marked as available to receive additional information from the database. In one embodiment, an index associated with the slot is reset to indicate that the slot is available for the addition of more information. In one embodiment, the slot is emptied if it is determined to be unavailable to store additional information without querying when the information was placed in the caching layer or when the information was last accessed. This can facilitate caching layer speed and operation because characteristics of the information in the unavailable slot that is determined to be full and therefore unavailable for additional information are not investigated. Instead, the information may be emptied regardless. Optimal use of the caching layer also may be obtained, for example, by clearing slots when a predetermined usage threshold is reached, by clearing a minimum number of slots to ensure a predetermined minimum amount of available cache remains available, and the like.

The information that was in the emptied slot may still exist in the database, however. If that item of database information is accessed again, it may again be transferred to at least one slot in the plurality of slots the caching layer. Similarly, an index associated with the at least one slot may be updated to enable rapid access of the cached information. This further facilitates maintenance of the most accessed information on the caching layer while deleting older information in an efficient manner.

In another embodiment, a signature may be generated based, in part, on the data requested, to identify data stored in the caching layer. The signature may then be employed to invalidate the data in the caching layer, when the data changes in database. Invalidation of such data across multiple web servers, such as those with local cache sources, may also be accomplished through the use of an invalidation broadcasts.

Illustrative Operating Environment

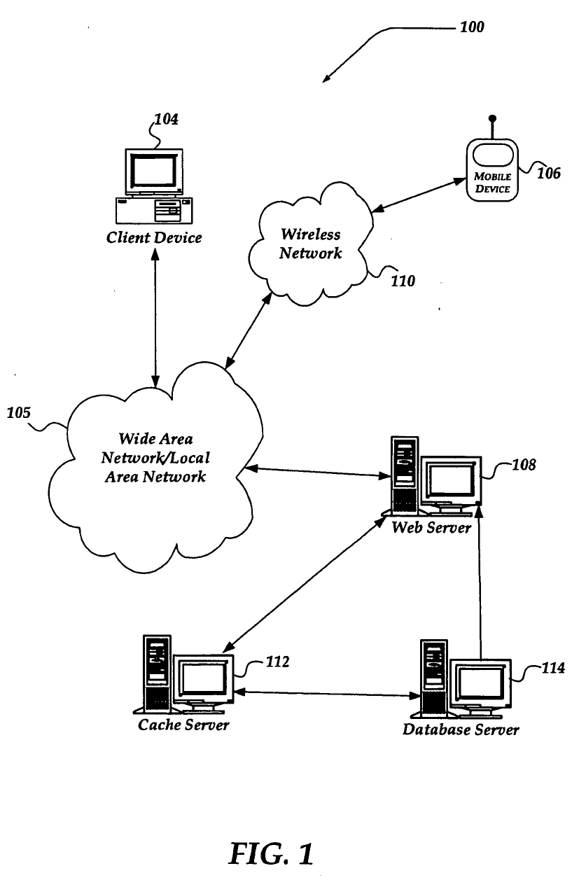

FIG. 1 shows components of an environment 100 in which the inventions may be practiced. Not all the components may be required to practice the inventions, and variations in the arrangement and type of the components may be made without departing from the spirit or scope of the inventions. As shown, system 100 of FIG. 1 includes client device 104, mobile device 106, local area networks (“LANs”)/wide area networks (“WANs”) 105, wireless network 110, web server 108, cache server 112, and database server 114.

Client device 104 and mobile device 106 can be used to retrieve or add database information on the database server 114 via the web server 108. Generally, mobile device 106 can include virtually any computing device capable of connecting to another computing device and receiving information. Such devices include portable devices such as, for example, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, and the like. Mobile device 106 may also include other computing devices, such as personal computers, multiprocessor systems, microprocessor-based or programmable consumer electronics, network PCs, and the like. As such, mobile device 106 typically ranges widely in terms of capabilities and features. For example, a cell phone can have a numeric keypad and a few lines of monochrome LCD display on which only text may be displayed. In another example, a web-enabled mobile device has a touch sensitive screen, a stylus, and several lines of color LCD display in which both text and graphics may be displayed. Moreover, the web-enabled mobile device can include a browser application enabled to receive and to send wireless application protocol messages (WAP), and the like. In one embodiment, the browser application is enabled to employ a Handheld Device Markup Language (HDML), Wireless Markup Language (WML), WMLScript, JavaScript, and the like, to display and send a message.

Mobile device 106 can include at least one client application that is configured to receive content from another computing device, such as web server 108. The client application may include a capability to provide and receive one or more of textual content, graphical content, audio content, and the like, including, but not limited to, content in the form of files, web pages, e-mail, or messages. The client application may further provide information that identifies itself, including a type, capability, name, identifier, and the like. The information may also indicate a content format that mobile device 106 is enabled to employ. Mobile device 106 may also be configured to communicate a message, such as through a Short Message Service (SMS), Multimedia Message Service (MMS), instant messaging (IM), internet relay chat (IRC), mIRC, Jabber, and the like, between itself and another computing device, such as web server 108, and the like.

Client device 104 represents another embodiment of a device, such as a personal computer, multiprocessor system, microprocessor-based or programmable consumer electronics, network PC, and the like, that can connect to web server 108. Client device 104 may operate substantially similar to mobile device 106 in many ways, and different in other ways. For example, client device 104 can represent more traditional wired devices. As such, client device 104 can be configured to communicate with web server 108, and other network devices, employing substantially similar mechanisms as mobile device 106 for wired device implementations.

Client device 104 and mobile device 106 can include a browser application that is configured to receive and to send web pages, web-based messages, and the like. The browser application may be configured to receive and display graphics, text, multimedia, and the like, employing virtually any web based language, including Standard Generalized Markup Language (SMGL), such as HyperText Markup Language (HTML), and so forth. Client device 104 may further include a client application that enables it to perform a variety of other actions, including, communicating a message, such as through a Short Message Service (SMS), Multimedia Message Service (MMS), instant messaging (IM), internet relay chat (IRC), mIRC, Jabber, and the like, between itself and another computing device.

Wireless network 110 is configured to couple mobile device 106 and its components with WAN/LAN 105. Wireless network 110 may include any of a variety of wireless sub-networks that may further overlay stand-alone ad-hoc networks, and the like, to provide an infrastructure-oriented connection for mobile device 106. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G) or 3rd (3G) generation radio access for cellular systems, WLAN, Wireless Router (WR) mesh, and the like. Access technologies such as 2G, 3G, and future access networks may enable wide area coverage for mobile devices, such as mobile device 106 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device 106 and another computing device, network, and the like.

Network 105 is configured to couple web server 108 and its components with other computing devices, including client device 104, web server 108, and through wireless network 110 to mobile device 106. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between web server 108 and another computing device. Furthermore, the number of WANs, and LANs in FIG. 1 may be increased or decreased arbitrarily.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Web server 108, cache server 112, and database server 114 can be coupled in any manner including, but not limited to, the Internet; local area networks (LANs); wide area networks (WANs); direct connections, such as through a universal serial bus (USB) port or through other forms of computer-readable media; mesh networks; Wireless LAN (WLAN) networks; cellular networks; or any combination thereof. Moreover, the manner of connection between any two types of servers (e.g., between web servers and database servers) can be the same or different from that between any other two types of servers (e.g., between web servers and cache servers or between cache servers and database servers). Furthermore, a server may also act as any combination of web server, cache server, and database server.

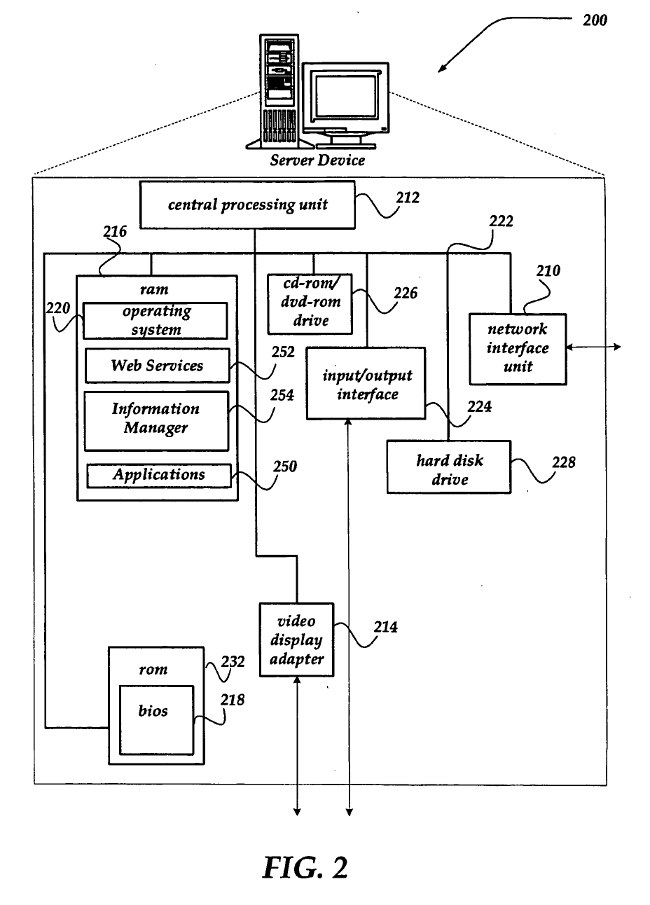

One embodiment of a server, that operate as web server 108, cache server 112, database server 114, or combination thereof, is described in more detail below in conjunction with FIG. 2. Briefly, however, web server 108 typically includes any computing device capable of connecting to network 105 to receive database information or requests for database information from another computing device, such as client device 104 and mobile device 106.

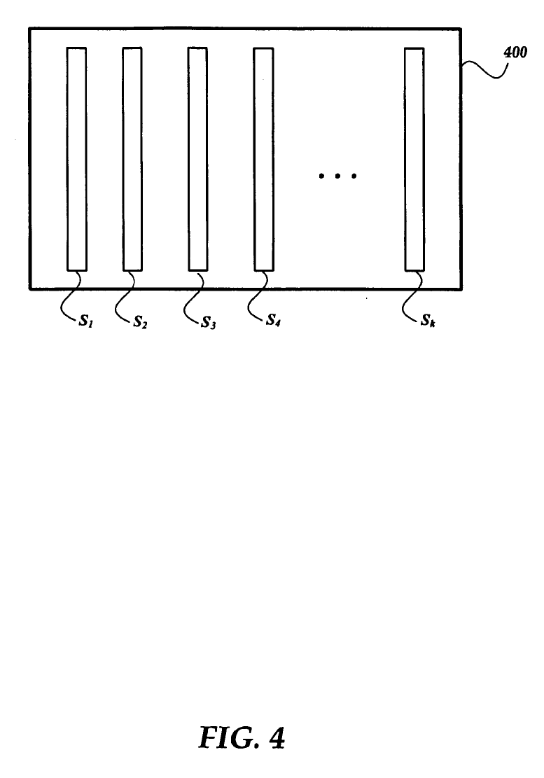

Cache server 112 typically includes any computing device that can store database information and can receive information from database server 114, transmit information to the web server 108, and enable a search for information based on a request from web server 108. Cache server 112 includes one or more storage mechanisms that are configured to operate as cache storage, for the storage and access of information, such as blog content. The cache storage is arranged into one or more slots, as described in more detail below in conjunction with FIG. 4. Information stored within a slot may be located and accessed employing an index. In one embodiment, a distinct index is associated with each of the one of more slots.

Database server 114 typically includes any computing device that can store database information, transmit database information to web server 108 and/or cache server 112; and search for information within a database application, and the like, based on a request from the web server. Devices that may operate as web server 108, cache server 112, or database server 114 include, but are not limited to, personal computers desktop computers, multiprocessor systems, microprocessor-based or programmable consumer electronics, network PCs, servers, and the like.

Although illustrated above using a database application, the invention is not so limited. Virtually any application, service, and the like, may be employed to take advantage of the present invention. Thus, for example, database server 114 may be replaced with or made available in conjunction with a non-database application, service and the like.

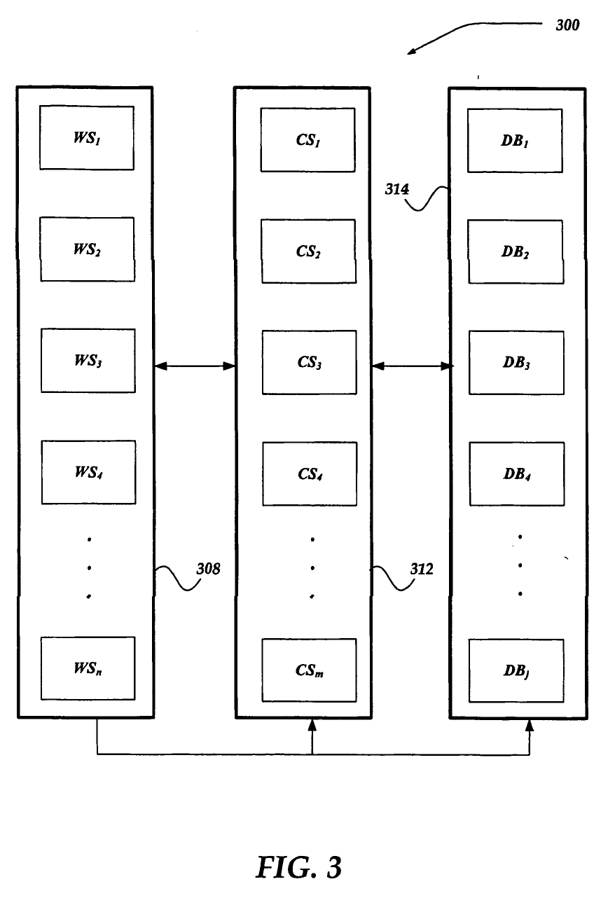

In addition, although FIG. 1 illustrates a single computing device operating as web server 108, cache server 112, and database server 114, the invention is not so constrained. Rather, the invention enables scalability by improving caching actions of cache server 112. Thus, in one embodiment, any of web server 108, cache server 112, and database server 114 may be implemented as an array of computing devices, a cluster arrangement or servers, and the like. One such embodiment is described in more detail below in conjunction with FIG. 3.

Illustrative Server Environment

FIG. 2 shows one embodiment of a server device, according to one embodiment of the invention. Server device 200 may include many more components than those shown and may not include all of the components shown in FIG. 2. The components shown, however, are sufficient to disclose an illustrative embodiment for practicing the invention. Server device 200 may, for example, be employed to operate as web server 108, cache server 112, and/or database server 114 of FIG. 1. Components may be the same or different for each type of server or even for servers of the same type.

Server device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server device 200. As illustrated in FIG. 2, server device 200 also can communicate with the Internet, or some other communications network, such as network 105 and wireless network 10 in FIG. 1, via network interface unit 210, which is constructed for use with various communication protocols including TCP/IP protocol, UDP/IP protocol, and the like. Network interface unit 210 is sometimes known as a transceiver, transceiving device, network interface card (NIC), and the like.

Server device 200 may also include an SMTP handler application for transmitting and receiving email. Server device 200 may also include an HTTP handler application for receiving and handing HTTP requests, and an HTTPS handler application for handling secure connections. The HTTPS handler application may initiate communication with an external application in a secure fashion.

Server device 200 also includes input/output interface 224 for communicating with external devices, such as a mouse, keyboard, scanner, or other input devices not shown in FIG. 2. Likewise, server device 200 may further include additional mass storage facilities such as CD-ROM/DVD-ROM drive 226 and hard disk drive 228. Hard disk drive 228 is utilized by server device 200 to store, among other things, application programs, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code, data, and other information, including the database information. One or more applications 250 are loaded into mass memory and run on operating system 220. Examples of application programs include email programs, schedulers, calendars, security services, transcoders, database programs, word processing programs, spreadsheet programs, and so forth. Mass storage may further include applications such as web services 252 and information manager 254.

Web services 252 are configured to manage requests from a client or mobile device's browser application and deliver web-based content in response. As such, web services 252 may include such applications as Apache, Internet Information Server (IIS), Netscape, National Center for Supercomputing Applications (NCSA), and the like. In one embodiment, web services 252 communicate with the client's browser application employing HTTP. However, web services may also execute server-side scripts (CGI scripts, JSPs, ASPs, and so forth) that provide functions such as database searching, e-commerce, and the like. In one embodiment of a web server 108, web services 252 interacts with information manager 254 to receive information or a request for information from a client device 104 or mobile device 106 and direct the information or request for information to the cache server 112 or database server 114 or both. The information manager 254 on one or more of the servers can also be used to search the cache server 112 or database server 114. The information manager 254 can also direct a slot within cache server 112 to be emptied when it is determined to be unavailable for storage of additional information, as is described below.

FIG. 3 schematically shows an embodiment of the web server, cache server, and database server of FIG. 1 configured to operate as arrays of web servers, cache servers, and database servers. Although illustrated as database servers, the invention is not so constrained, and one or more of the computing devices within FIG. 3 may provide non-database applications, services, and the like, without departing from the scope or spirit of the invention. Moreover, although described as an array of servers, the invention is not constrained to any particular computing architecture, and another may readily be employed. For example, a cluster architecture may be employed. Thus, the term “layer’ is employed below.

As shown in FIG. 3, configuration 300 includes web server layer 308, caching layer 312, and database layer 314. Caching layer 312 is in communication with web server layer 308 and database layer 314. Web server layer 308 is further in communication with database layer 314.

Web server layer 308 includes one or more web servers WS₁-WSₙ. Any one or more of web servers WS₁-WSₙ may be employed to provide service a request from a client device, mobile device, and the like. The selection of web server WS₁-WSₙ may be determined employing any of a variety of mechanisms. For example, a web server within web server layer 308 may be determined employing a domain name assignment mechanism, a geographical mechanism, and the like. Moreover, virtually any load balancing may be employed to select a web server within web server layer 308, including round trip time (RTT), round robin, least connections, packet completion rate, quality of service, traffic management device packet rate, topology, global availability, hops, a hash of an address in a received packet, static ratios, and dynamic ratios.

Caching layer 312 includes one or more cache servers CS₁-CSₘ. Typically, any of cache servers CS₁-CSₘ can be used as to provide services as described above for cache server 112 of FIG. 1. The selection of cache server may be determined employing any of a variety of mechanisms, including a load balancing mechanism, including those described above in conjunction with web server layer 308.

Each of cache servers CS₁-CSₘ are configured to operate as a cache server, proxying requests for information between computing devices, such as those within web server layer 308 and database layer 314. In addition, cache servers CS₁-CSₘ may include cache, memory, and/or other storage components, that are arranged into slots as described in more detail below in conjunction with FIG. 4.

Database layer 160 includes one or more database servers DB₁-DBⱼ. Typically, any of the database servers can be used to provide services associated with database server 114 of FIG. 1. The selection of database server may also be determined employing virtually any mechanism, including being based on an application type, a database content, a load balancing mechanism such as described above, and so forth.

In one embodiment, data coherency may be maintained across the one or more web servers WS₁-WSₙ, and the one or more database servers DB₁-DBⱼ. through the use of an invalidation broadcast. Briefly, an invalidation broadcast includes a notification that data has been changed and that any copies of that data should be updated, marked as invalid, or the like.

In another embodiment, a signature based on data requested may be generated that identifies data in cache servers CS₁-CSₘ. The signature may be further used to invalidate the data in cache servers CS₁-CSₘ, web servers WS₁-WSₙ, and the like, if the data in the database is changed. For example, the signature may be provided in an invalidation broadcast message.

FIG. 4 illustrates one embodiment of slot system 400. As shown in the figure, slot system includes slots S₁-Sₖ, where k may be virtually any integer value greater than zero. Slot system 400 may represent virtually any storage device, including a fast disk, optical storage, RAM, and the like.

Slot system 400 is configured such that if information is retrieved from a database layer, it is stored in one of the slots S₁-Sₖ. The particular slot in which the information is to be stored can be selected in any manner including, for example, filling a slot and then moving to the next slot; sequentially rotating through slots S₁-Sₖ with each item of information going into a next slot in the rotation; selecting a slot randomly, and the like.

Each slot in slots S₁-Sₖ may be arranged to store a predetermined amount of data which can be measured in any desired way including, for example, by a size of the information in bytes, by a number of individual pieces of information (e.g., individual messages, blog entries, or webpages). In one embodiment, each slot of slots S₁-Sₖ is configured to hold 100 messages, such as blog entries, web pages, and the like. However, the invention is not so limited, and other sizes may be employed. Moreover, at least one slot may be arranged to store a different amount of data than another slot.

In one embodiment, once a slot is determined to be unavailable to store additional information, then all of the information stored in the slot may be erased, deleted, or the like, and the slot is marked as marked as available for storing more information. The information is the unavailable slot, however, need not be erased, or deleted, however. In one embodiment, for example, the information is marked as available to be written over. The number of slots, the manner of filling the slots, and the size of the slots can be selected, if desired, to achieve a predetermined efficiency. If, for example, the database is queried more than desired because the relevant information is not in the caching layer, the number of slots, the size of the slots, and the like, can be increased. If, for example, a search time for the caching layer is more than desired, the number of slots, the size of the slots, and the like, can be reduced.

The number of slots to be emptied may also be determined based on a predetermined usage threshold. That is, if the predetermined usage threshold is reached, then one or more slots may be cleared. Thus, the predetermined usage threshold may be associated with a slot, a group of slots, or even the entire cache layer of slots. Moreover, in one embodiment, a predetermined minimum number of slots may be cleared to ensure that a predetermined minimum amount of cache memory remains available.

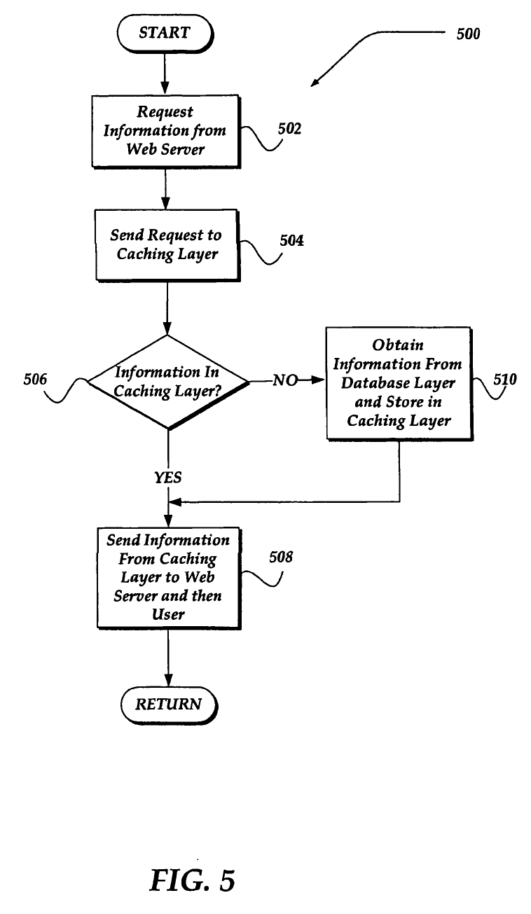

FIG. 5 illustrates one embodiment of a process flow 500 for managing requests for information over a network. Process flow 500 may be implemented, for example, employing environment 100 of FIG. 1.

Process flow 500 begins, after a start block, at block 502, where a request for information is made to a web server. Such requests can include, but are not limited to, opening a webpage, accessing a message board, accessing a blog, requesting a display of the most recent entry or entries, opening a message on a message board or attached to a displayed blog entry, requesting earlier messages or blog entries which are not initially displayed upon opening the blog or message board. Processing flows next to block 504, where the received request is sent towards a caching layer.

Processing continues next to decision block 506, where a determination is made whether information requested is available in the caching layer. The caching layer looks to its slots to determine whether the information resides within a slot. In one embodiment, an index is employed to rapidly determine if the information is within a slot. If the requested information is unavailable in any of the slots of the caching layer, processing branches to block 510; otherwise, processing continues to block 508.

At block 510, the caching layer proxies the request for information towards the database server layer. The database layer may search for the information and forward it to the caching layer. The requested information is then stored in an available slot of the caching layer. After storage on the caching layer, the requested information is forwarded to the web server and then the requester. As an alternative, the requested information may be sent to the web server directly from the database layer while the information is also stored on the caching layer.

At block 508, the requested information is sent towards the appropriate web server associated with the request. In one embodiment, the caching layer provides the requested information towards the appropriate server. The web server then may forward the requested information towards the requesting device. Upon completion of block 508, process flow 500 returns to a calling process to perform other actions.

Using a caching layer, as described above, can increase the efficiency of database operation because only a portion of the database information is searched during the initial search of the caching layer. The replacement of older information with new information in the caching layer results in the information most likely to be accessed within the caching layer. Therefore, the most likely set of information is first queried instead of searching through the entire database. In addition, additional cache servers can be added to the caching layer to provide additional caching slots. This can be particularly useful as the size of the database grows. In one embodiment, additional cache servers are added when the number or percentage of queries sent to the database layer meets or exceeds a threshold or when the response time to a query meets or exceeds a threshold.

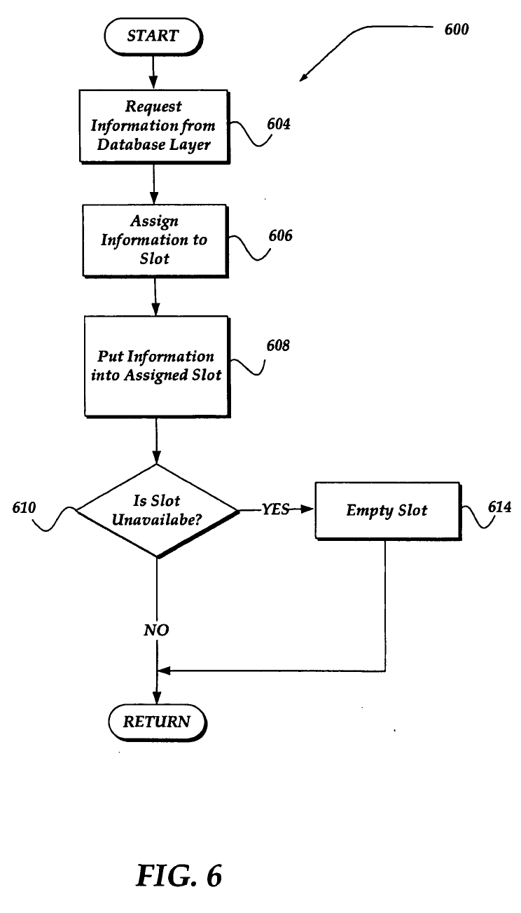

FIG. 6 is a flowchart illustrating one embodiment process 600 of receiving and storing information in a caching layer. Process 600 may be implemented in caching layer 312 of FIG. 3, for example.

Process 600 begins, after a start block, at block 604, where a request for information is sent to a database layer. At 605, the requested information is also received from the database layer.

Processing continues next to block 606, where the received information is assigned to a slot. Selection of a slot may be based on any of a variety of mechanisms, including those described above. For example, a slot may be selected from a sequence of non-full slots, from a random selection of non-full slots, and the like. Once a slot is selected, processing continues to block 608, where the information is stored within the assigned slot. In one embodiment, an index associated with an assigned location within the slot is incremented appropriately. In another embodiment, the stored information is also forwarded to the requesting device.

Processing continues next to decision block 610, where a determination is made whether a slot is determined to be unavailable to store additional information. Determination of whether a slot is unavailable to store additional information may be based on a variety of criteria. For example, a slot may be unavailable to store additional information based, at least in part, on satisfying a predetermined usage threshold. Thus, in one embodiment, one or more slots may be unavailable to store additional information, if, for example, the predetermined usage threshold is reached.

The determination that a slot is unavailable to store additional information may also be based, at least in part, on a mechanism that seeks to ensure that a minimum amount of cache memory (in terms of slots) remains available for use. Thus, in one embodiment a predetermined minimum number of slots may be determined to be unavailable to store additional information and to be emptied, to ensure the availability of the minimum amount of cache memory.

It is important to note, however, that a slot may be determined to be unavailable to store additional information, although one or more bits within a slot are unallocated. This may arise, for example, simply because the available bits are determined to be insufficient to store a message, a data packet, and the like.

In any event, if a slot is determined to be unavailable to store additional information, processing branches to block 614; otherwise, processing returns to a calling process to perform other actions. At block 614, the slot that is unavailable to store additional information is emptied, employing any of a variety of mechanisms, including marking the slot as empty, marking each location within the slot as empty, erasing the information within the slot, and the like. In addition, the slot is marked as available to store information. In one embodiment, the index associated with the slot is reset to a predetermined initial state, such as one, a value associated with the slot's relationship to other slots, and the like. Processing then returns to the calling process.

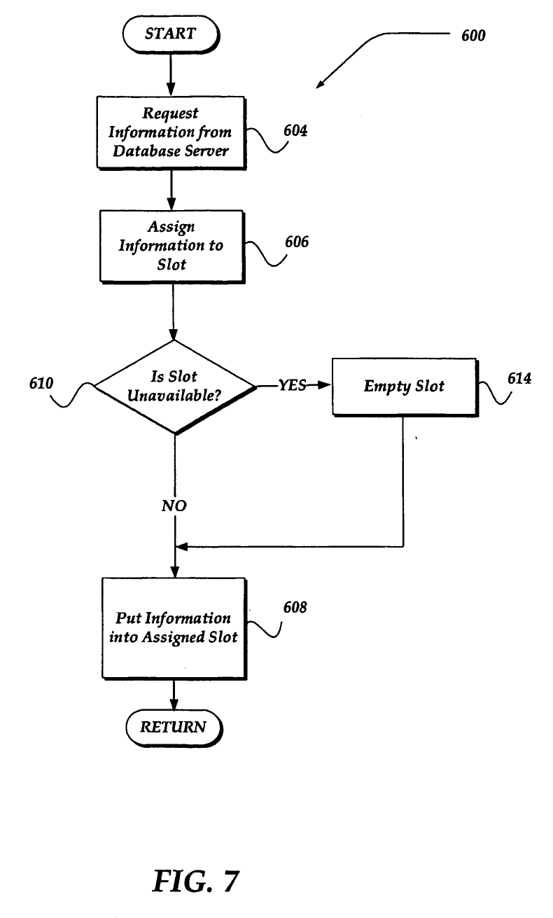

In an alternative embodiment illustrated in FIG. 7, the slot is queried to determine if it is unavailable to store additional information (block 610) prior to storing the item of information (block 608). If the slot is available to store additional information, then the additional information is added to the slot (block 608). If the slot is unavailable to store additional information, then the slot is emptied (block 614), and the slot is marked as available to store information, and the additional information is subsequently added to the slot (block 608). In one embodiment, the index associated with the slot is also updated to reflect the empting of the slot, and the addition of the subsequent information.

When new information is added to a database by a user, that information is stored in the database layer and may become part of the caching layer when it is accessed. Alternatively, new information may be initially stored at both the caching layer and the database layer. In some embodiments, storage of information at the caching layer may be limited to the most used webpages, blogs, message boards, and the like, limited to subscribers that pay an additional fee, and the like. Information that is not designated as eligible for storage on the caching layer may still be stored and accessible at the database layer. However, when such information is accessed, it may not be delivered to the caching layer, but, instead, may be delivered directly to the web server layer for distribution to the requester.

The caching layer can be used with any database including, for example, databases that support weblogs (“blogs”), webpages, message boards, and so forth. One example of a suitable use for this invention is in connection with weblogs or blogs, as described further below. It may be understood that this is an example and that the description below can be adapted or used with other types of information.

As the blogger writes entries in his blog and as readers and the blogger comment on the blog entries, a large amount of information is generated. This information is typically stored in a database. After the blogger adds entries to the blog, readers can open the blog and read the entries. If desired, the readers and blogger can provide comments or messages to entries made by the blogger. These comments and messages are then viewable by the blogger and other readers. Optionally, the blogger or service provider can restrict or prevent comments and messages from all or some readers. Also, optionally, the blogger, reader, or service provider (or a combination thereof) can restrict access to the blog, certain blog entries, comments, or messages to a subset of users. For example, the blogger may restrict access to the blog or to particular blog entries to a group of the blogger's friends or associates. As another non-limiting example, in some embodiments, a reader may restrict access to a message or comment to the blogger or to a group of people.

Generally, bloggers and readers are most interested in the latest entries, messages, and comments on the blog. As these items are accessed they are put into a caching layer for quick retrieval by others. Older entries, messages, and comments are less likely to be accessed although they typically may be stored on the database for later reference and review. Accordingly, only a subset of the blog information is stored in the caching layer to improve access speed. The subset of information stored in the caching layer is the most recently requested information which represents the most likely information to be requested by other readers and bloggers. If the requested information is not found in the caching layer, the database can be queried for the requested information.

A service provider can provide a blogging service with more than one blogger generating individual blogs. The database can quickly become large and can be cumbersome and slow to access information. The service provider can have a caching layer for all blogs or the service provider can limit the use of the caching layer to a subset of blogs, for example, the most accessed blogs or blogs where an extra service fee is paid, or the service provider can limit the use of the caching layer to a subset of blog information, for example, entries by the blogger only or by bloggers and others that pay an extra service fee. The discussion below relates to blog information or blogs that have access to the caching layer.

When a blogger inputs information (e.g., a blog entry) to the blog, that information is transferred to the web server layer and then forwarded to the database layer, and optionally the caching layer, for storage. Similarly, messages or comments from readers or the blogger are transferred to the web server layer 106 and then written to the database layer, and optionally the caching layer. The blog, comments, and messages can include any type of information which is allowed by the service provider and can be from any source which is allowed by the service provider. The information provided by the blogger or reader can be, for example, text, graphics, audio files, video files, picture files, software files, data files, web pages or combinations thereof. Sources of information include, for example, web pages, e-mail, messaging services, and the like.

Information accessed by the blogger or reader which is not found on the caching layer is then transmitted to the caching layer for storage in one of the slots, as described above. In one embodiment, the caching layer slots can be filled without any regard as to which blog generated the information (as long as the service provider has allowed the blog use of the caching layer). In other words, the caching layer slots are filled with the most recent information accessed from any blog. The least accessed blogs or those with more infrequent entries and comments/messages may be less represented in the caching layer.

As one alternative, each blogs can be assigned a particular number of caching layer slots to be used only by that blog. In one embodiment, all of the blogs receive the same number of caching layer slots. In another embodiment, the number of slots that a blog receives is based on one or more criteria, such as, for example, the amount of traffic to the blog, the size of information associated with the blog, the amount paid for the service by the blogger (e.g., there may be multiple service levels from the provider), the subject matter of the blog, the identity or personal characteristics of the blogger, and the frequency of blog entries.

As yet another alternative, the caching layer slots may be divided among groups of blogs. For example, a first group of blogs have a first level of service and are given a particular number of caching layer slots as a group, while a second group of blogs with a second level of service are given a smaller number of caching layer slots as a group. The distribution within the group of the caching layer slots assigned to the group can be based on any criteria, including filling the slots based on information received or requested from the group of blogs as a whole.

Use of a caching layer with blogs or other information can facilitate faster access times for the information most likely of interest to a reader. The automatic emptying of a slot when it is determined to be unavailable to store additional information can facilitate removal of old information without querying how long that information has been in a slot or whether the information has been recently accessed. If the information is accessed again after the slot has been emptied, the information may again be placed on the caching layer.

It may be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It may also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method for managing information over a network, the method comprising:
receiving a request for information;
searching at least one of a plurality of slots in a caching layer to find the requested information, wherein each slot is arranged to store a plurality of information;
if the requested information is unavailable in the plurality of slots, searching a database layer to locate the requested information, wherein the located information is stored in at least one available slot and provided in a response to the request; and
if any one of the plurality of slots in the caching layer is determined to be unavailable for further storage of information, the unavailable slot is emptied of information and marked as available for storing further information.

2. The method of claim 1, wherein each slot of the caching layer is configured to store a predetermined amount of information.

3. The method of claim 1, wherein the requested information relates to a blog.

4. The method of claim 1, wherein the request for information is from a mobile device.

5. The method of claim 1, wherein storing the located information in at least one available slot further comprises employing a sequential arrangement of the plurality of slots to store the located information.

6. The method of claim 1, wherein searching at least one of a plurality of slots in a caching layer to find the requested information further comprises employing at least one of a plurality of indices, each index in the plurality of indices being associated with a different slot within the plurality of slots.

7. The method of claim 1, wherein determining if the slot is unavailable for further comprises comparing an amount of information stored in the slot to a predetermined usage threshold.

8. The method of claim 1, wherein emptying the unavailable slot of information further comprises marking the unavailable slot as empty.

9. The method of claim 1, wherein emptying the unavailable slot of information further comprises at least one of erasing the information in the unavailable slot, and marking the information in the unavailable slot as available to be written over.

10. The method of claim 1, wherein determining if the slot is unavailable for further storage of information further comprises determining if a predetermined minimum number of slots in the plurality of slots is available.

11. A system for storing and accessing information, the system comprising:
a client device that is arranged to request information;
a database layer arranged to store information; and
a caching layer that includes a plurality of slots and is arranged to perform actions, including:
receiving the request for information;
searching at least one of the plurality of slots to find the requested information, wherein each slot is arranged to store a plurality of information;
if the requested information is unavailable in the plurality of slots, searching the database layer to locate the requested information, wherein the located information is stored in at least one available slot and provided in a response to the request; and
if any one of the plurality of slots is determined to be unavailable for further storage of information, the unavailable slot is emptied of information and marked as available for storing further information.

12. The system of claim 11, wherein the client device is a mobile device.

13. The system of claim 11, wherein the caching layer further comprises a plurality of cache servers.

14. The system of claim 11, further comprising a web server that is configured to receive the request for information from the client device and to query the caching layer for the requested information.

15. The system of claim 11, the database layer is further configured to provide an invalidation broadcast towards the caching layer, if the information within the database server is changed.

16. The system of claim 15, wherein the invalidation broadcast further includes a signature associated with the changed information.

17. The system of claim 11, wherein the database layer further comprises a plurality of database servers.

18. The system of claim 11, wherein the plurality of slots are further configured to be used in a sequential arrangement for storing the located information.

19. A method for storing and accessing blog information, the method comprising:
receiving a request for blog information from a web server;
searching at least one of a plurality of slots in a caching layer to find the requested blog information, wherein each slot is arranged to store a plurality of blog information;
if the requested blog information is unavailable in the plurality of slots, searching a blog database to locate the requested blog information, wherein the located blog information is stored in at least one available slot and provided in a response to the request; and
if any one of the plurality of slots in the caching layer is determined to be unavailable for further storage of blog information, the unavailable slot is emptied of blog information and marked as available for storing further blog information.

20. The method of claim 19, wherein determining if the slot is unavailable for further storage of blog information further comprises determining if a predetermined minimum number of slots in the plurality of slots is available.

21. The method of claim 19, wherein determining if the slot is unavailable for further storage of information further comprises employing a predetermined usage threshold.

22. A modulated data signal for communicating content over a network, the modulated data signal comprising:
sending a request for information;
enabling a search of at least one of a plurality of slots in a caching layer to find the requested information, wherein each slot is arranged to store a plurality of information;
if the requested information is unavailable in the plurality of slots, enabling a search of a database to locate the requested information, wherein the located information is stored in at least one available slot and provided in a response to the request; and
if any one of the plurality of slots in the caching layer is determined to be unavailable for further storage of information, enabling the unavailable slot to be emptied of information and being marked as available for storing further information.

23. The modulated data signal of claim 22, wherein the information comprises blog information.

24. The modulated data signal of claim 22, wherein enabling the search to find the requested information further comprises employing at least one of a plurality of indices, each index in the plurality of indices being associated with a different slot within the plurality of slots.

25. The modulated data signal of claim 22, wherein determining if the slot is unavailable for further storage of information further comprises comparing the amount of information stored within the slot to a predetermined usage threshold.

26. A cache server, comprising:
a transceiver for receiving and sending content over the network;
a memory for storing information; and
a processor configured and arranged to perform actions, including:
receiving a request for information;
searching at least one of a plurality of slots in the cache server to find the requested information, wherein each slot is arranged to store a plurality of information;
if the requested information is unavailable in the plurality of slots, searching a database to locate the requested information, wherein the located information is stored in at least one available slot and provided in a response to the request; and
if any one of the plurality of slots in the cache server is determined to be unavailable for further storage of information, the unavailable slot is emptied of information and marked as available for storing further information.

27. The cache server of claim 26, wherein the request is received from a mobile device.

28. The cache server of claim 26, wherein determining if the slot is unavailable for further storage of information further comprises employing a predetermined usage threshold.

29. The cache server of claim 26, wherein determining if the slot is unavailable for further storage of information further comprises evaluating the plurality of slots employing a first-in, first-out mechanism.
